(19) United States
(12) Patent Application Publication
(10) Pub. No.: US 2026/0266114 A1
(43) Pub. Date: Sep. 10, 2026

(54) Rotary Shaft Rotatable at Multiple Angle and Screen Apparatus

(71) Applicant: Shenzhen Xinshuo Technology Co., Ltd., Shenzhen (CN)

(72) Inventor: Changping Jian, Shenzhen (CN)

(21) Appl. No.: 19/220,029

(22) Filed: May 27, 2025

(30) Foreign Application Priority Data
Mar. 7, 2025 (CN) 202510269012.2

(51) Int. Cl. E05D 11/10; E05D 11/08; G06F 1/16

(52) U.S. Cl. CPC E05D 11/1028; E05D 11/08; G06F 1/1681

(57) ABSTRACT

A rotary shaft rotatable at multiple angles and a screen apparatus are provided. The rotary shaft rotatable at multiple angles includes a mounting base, a first rotary shaft set and a second rotary shaft set, where the first rotary shaft set and the second rotary shaft set respectively include a rotary shaft unit; the rotary shaft unit includes a rotary shaft having one end rotatably connected to the mounting base and the other end provided with a connection end, a wiring channel extending through two ends thereof is provided in the rotary shaft, and has one end correspond to the connection end and the other end correspond to the other end of the wiring channel of the second rotary shaft set.

### CROSS REFERENCE TO RELATED APPLICATIONS

The present application claims the benefit of Chinese Patent Application No. 202510269012.2 filed on March 7, 2025, the contents of which are incorporated herein by reference in their entirety.

### TECHNICAL FIELD

The present invention relates to the field of rotary shafts, and more particularly, to a rotary shaft rotatable at multiple angle and a screen apparatus.

### BACKGROUND ART

With the continuous advancement of technology, various mechanical and electronic devices have been increasingly applied in daily life and industrial production. Among these, rotary shafts, as critical mechanical components, are extensively utilized in numerous devices to achieve physical connections between different parts and enable motion transmission functions.

However, in practice, while physical connections are established through rotary shafts, the issue of electrical connectivity cannot be overlooked. In numerous apparatuses, electrical connections such as power transmission or signal transfer between components are critical to ensure normal operation of the devices. For instance, in apparatuses where some sensors interface with data processing units, electrical connections are required to transmit signals collected by means of the electrical connections for analysis. In electric actuators, control signals must be delivered by means of the electrical connections to motor drivers to regulate operational states of the motor.

In the design and function realization of the traditional rotary shaft structure, the emphasis is put on the mechanical structure building and the perfection of the physical connection function, and the consideration of the electrical connection wiring channel is relatively less. In conventional designs, electrical connections to traces are often made by providing wiring holes, slots, etc. in a housing of the device, or by using external wiring patterns to connect the wires to the corresponding components. Although these approaches can solve the electrical connection problem to some extent, there are also a number of drawbacks.

On one hand, the operation of providing wiring holes, grooves, etc. on the housing of the device will damage the whole integrity and sealability of the housing of the device, so that foreign substances such as dust, moisture, etc. can easily enter the device, which will adversely affect the reliability and service life of the device. Particularly in application scenarios with stringent environmental requirements, such as outdoor equipment and food processing systems, such compromise to sealing may lead to critical safety risks and quality defects.

On the other hand, the use of external wiring not only makes the appearance of the device disordered, affects the aesthetics of the product as a whole, but also is prone to wire winding, pulling, etc. in the wiring process, which brings a lot of inconvenience to the installation, maintenance and use of the device. In addition, the external wiring is exposed to the external environment, and is vulnerable to electromagnetic interference, mechanical damage, etc. thus resulting in a great compromise in the stability and reliability of the electrical connection.

### SUMMARY OF THE INVENTION

In order to solve the above-mentioned problems, it is an objective of the present invention to provide a rotary shaft rotatable at multiple angles, and the rotary shaft unit can be used for physical connection between different components, so that the different components have the capability of adjustment of rotation at multiple angles; at the same time, wiring channels for electrical connections can also be provided.

Another objective of the present invention is to provide a screen apparatus which not only has a function of adjustment of rotation at multiple angles; but also the connection mode is a hidden connection, which is more stable and reliable, and can effectively avoid the potential safety hazards.

In order to achieve the above objective, the technical solution of the present invention is as follows:

a rotary shaft rotatable at multiple angles, which includes a mounting base, a first rotary shaft set for performing a first angle rotation on the mounting base, and a second rotary shaft set for performing a second angle rotation on the mounting base, where the first rotary shaft set and the second rotary shaft set respectively include a rotary shaft unit;

the rotary shaft unit includes a rotary shaft having one end rotatably connected to the mounting base and the other end provided with a connection end connected to an external component, a wiring channel extending through two ends thereof is provided in the rotary shaft, and has one end correspond to the connection end and the other end correspond to the other end of the wiring channel of the second rotary shaft set.

The first rotary shaft set and the second rotary shaft set may be respectively connected to two different external components, so that the two different external components can be rotationally adjusted at multiple angles; in addition, based on the arrangement of the wiring channels in the rotary shaft, when two different external components are electrically connected, the wires can pass through the wiring channels of the first rotary shaft set and the wiring channels of the second rotary shaft set successively, and this wiring method is not only more stable and reliable, but also can effectively avoid the potential safety hazard.

Further, the rotary shaft further includes a mounting box, where the mounting base is fixed in the mounting box, and one end of the rotary shaft extends into the mounting box and is rotatably connected to the mounting base.

Further, the number of the second rotary shaft sets is two or more, and the other ends of the wiring channels of the two or more second rotary shaft sets correspond to the other ends of the wiring channels of the first rotary shaft set.

Further, the mounting base includes a first mounting member having one end bent to form a second mounting member, the rotary shaft of the first rotary shaft set has one end rotatably connected to the first mounting member, and the rotary shaft of the second rotary shaft set has one end rotatably connected to the second mounting member.

Further, the mounting base is provided with a rotation hole through which one end of the rotary shaft passes to be rotatably connected with the mounting base.

Further, the rotary shaft unit further includes a damping sheet for controlling rotational damping between the mounting base and the rotary shaft, the damping sheet is sleeved over the rotary shaft, and the damping sheet abuts against the mounting base.

Further, the damping sheet is sleeved at one end of the rotary shaft, and first flat positions for limiting the rotation of the damping sheet are provided at one end of the rotary shaft.

Further, the first flat positions are provided on two opposite sides of one end of the rotary shaft.

Further, the rotary shaft unit further includes a spring set and a pressing ring, the spring set is sleeved at one end of the rotary shaft, and one end of the spring set abuts against the damping sheet; the pressing ring is movably sleeved at one end of the rotary shaft via a thread, and the pressing ring abuts against the other end of the spring set.

Further, the spring set includes a plurality of disc-shaped spring pieces.

Further, a positioning protrusion is provided on one side of the damping sheet, and a positioning groove corresponding to the positioning protrusion is provided on the mounting base.

Further, first inclined faces are provided on two sides of the positioning protrusion, second inclined faces are provided on two sides of the positioning groove, and the first inclined faces on two sides of the positioning protrusion respectively correspond to the second inclined faces on the two sides of the positioning groove.

Further, a limiting portion for limiting the rotation angle of the rotary shaft is provided at the other end of the rotary shaft, and the mounting base is provided with a limiting protrusion corresponding to the limiting portion.

Further, a limiting ring is sleeved at the other end of the rotary shaft, and the limiting portion is provided on the limiting ring.

Further, second flat positions for limiting rotation of the limiting ring is provided at the other end of the rotary shaft.

Further, the second flat positions are provided at two opposite sides of the other end of the rotary shaft.

A screen apparatus includes a body, a screen, and the rotary shaft according to any one of claims 1 to 8, where the body is connected to the connection end, the screen is connected to the mounting base, and the body passes through the wiring channel of the second rotary shaft set and the wiring channel of the first rotary shaft set to be electrically connected to the screen. Based on the arrangement of the rotary shaft, the body and the screen not only have the function of adjustment of rotation at multiple angles; at the same time, the connection mode between the body and the screen is a hidden connection mode, which is not only more stable and reliable, but also can effectively avoid potential safety hazards.

Further, the screen and the rotary shaft are both two or more in number, the body is connected to the connection ends of the two or more rotary shafts, the two or more screens are connected to the mounting bases of the two or more rotary shafts, respectively, and the body is electrically connected to the two or more screens through the two or more rotary shafts, respectively.

In the present invention, the advantageous effects lie in that the first rotary shaft set and the second rotary shaft set may be respectively connected to two different external components, so that the two different external components can be rotationally adjusted at multiple angles; in addition, based on the arrangement of the wiring channels in the rotary shaft, when two different external components are electrically connected, the wires can pass through the wiring channels of the first rotary shaft set and the wiring channels of the second rotary shaft set successively, and this wiring method is not only more stable and reliable, but also can effectively avoid the potential safety hazard.

### BRIEF DESCRIPTION OF THE DRAWINGS

FIG. 1 is a schematic structural diagram of a rotary shaft.

FIG. 2 is a schematic structural diagram of a mounting box with a hidden portion of a rotary shaft.

FIG. 3 is a schematic structural diagram of a rotary shaft unit of a second rotary shaft set.

FIG. 4 is an exploded view of a rotary shaft unit of a second rotary shaft set.

FIG. 5 is a schematic structural diagram of a rotary shaft unit of a first rotary shaft set.

FIG. 6 is a schematic structural diagram of a first viewing angle of a screen apparatus.

FIG. 7 is a schematic structural diagram of a second viewing angle of a screen apparatus.

FIG. 8 is an enlarged partial view at A of FIG. 7.

### REFERENCE NUMERALS

1. mounting base; 11. rotation hole; 12. positioning groove; 121. second inclined face; 13. limiting protrusion; 14. first mounting member; 15. second mounting member;

2. first rotary shaft set;

3. second rotary shaft set;

4. rotary shaft unit;

41. rotary shaft; 411. wiring channel; 412. connection end; 413. first flat position; 414. second flat position;

42. damping sheet; 421. positioning protrusion; 4211. first inclined face;

43. spring set; 431. disc-shaped spring piece;

44. pressing ring;

45. limiting ring; 451. limiting portion;

5. mounting box;

6. body;

7. screen.

### DETAILED DESCRIPTION OF THE INVENTION

In order that the objectives, aspects and advantages of the present invention will become more apparent, a more particular description of the present invention will be rendered by reference to the embodiments thereof which are illustrated in the appended drawings. It should be understood that the particular embodiments described herein are illustrative only and are not limiting.

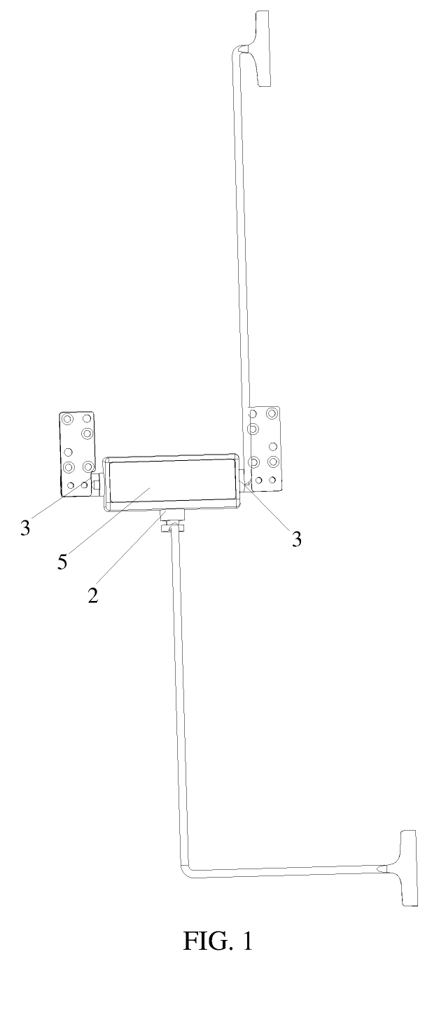

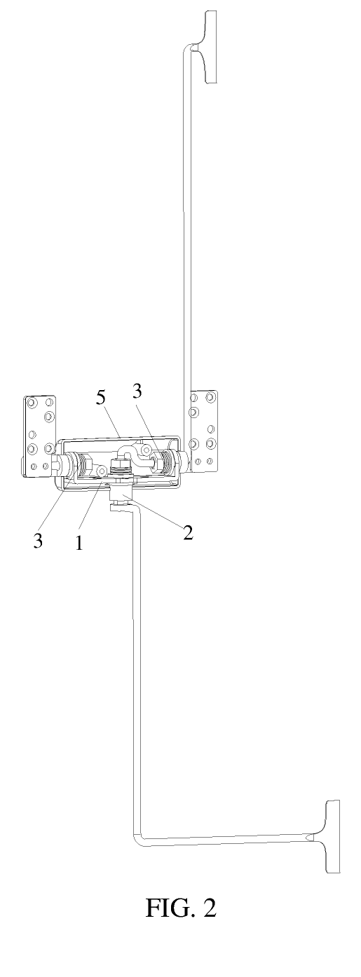

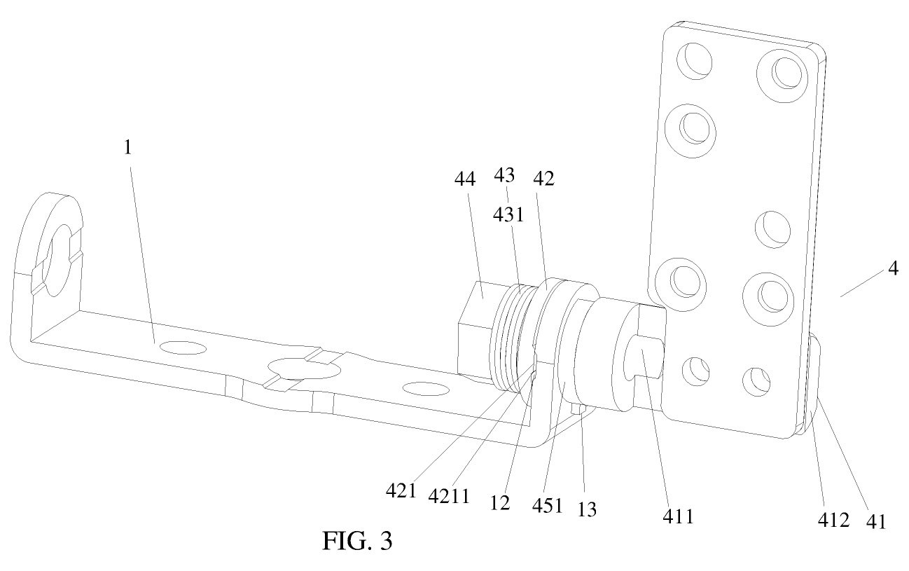

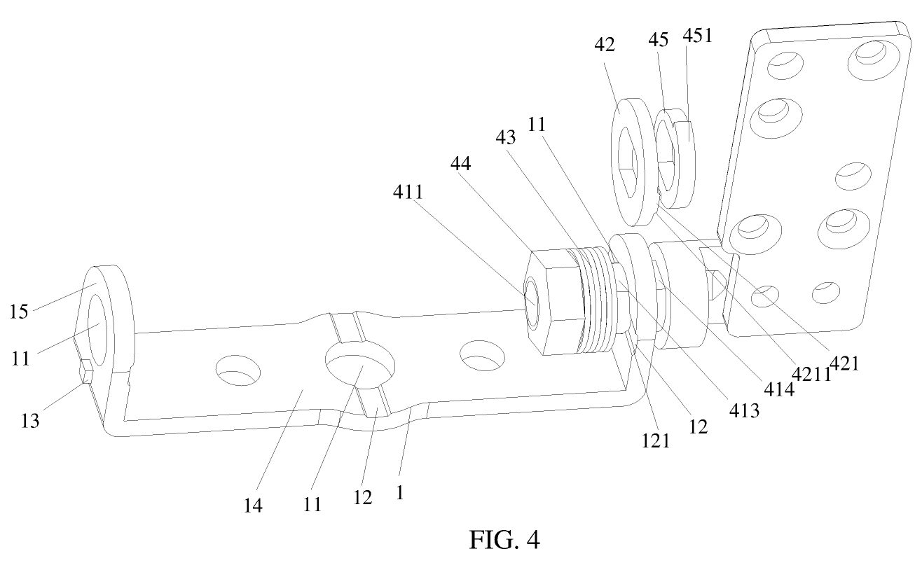

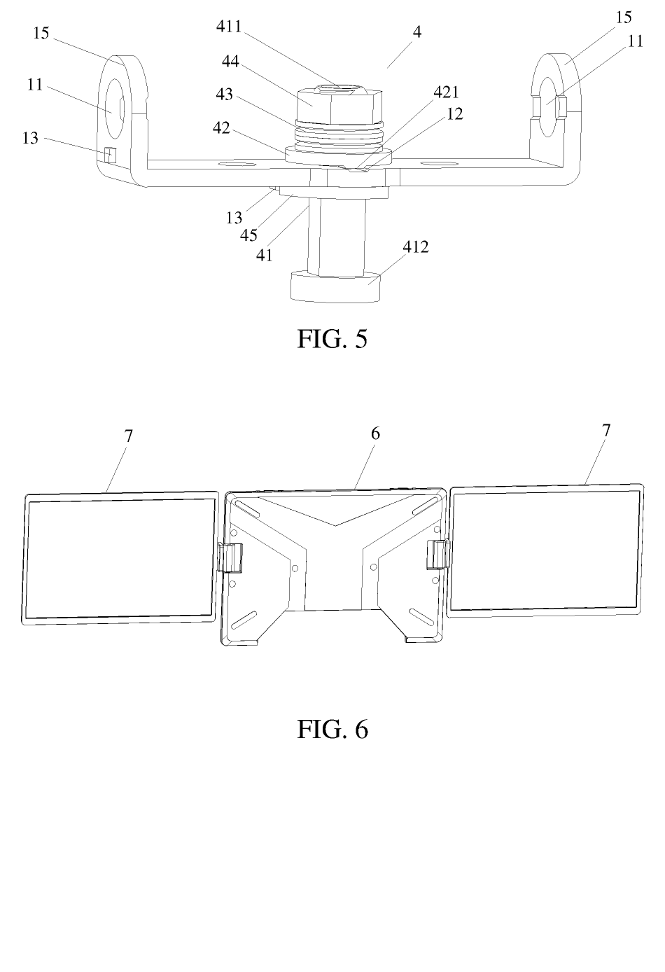

With reference to FIGS. 1-5, the present embodiment provides a rotary shaft rotatable at multiple angles, which includes a mounting base 1, a first rotary shaft set 2 for performing a first angle rotation on the mounting base 1, and a second rotary shaft set 3 for performing a second angle rotation on the mounting base 1, where the first rotary shaft set 2 and the second rotary shaft set 3 both include a rotary shaft unit 4;

the rotary shaft unit 4 includes a rotary shaft 41 having one end rotatably connected to the mounting base 1 and the other end provided with a connection end 412 connected to an external component, a wiring channel 411 extending through two ends thereof is provided in the rotary shaft 41, and has one end correspond to the connection end 412 and the other end correspond to the other end of the wiring channel 411 of the second rotary shaft set 3; and

the first rotary shaft set 2 and the second rotary shaft set 3 may be respectively connected to two different external components, so that the two different external components can be rotationally adjusted at multiple angles; in addition, based on the arrangement of the wiring channel 411 in the rotary shaft 41, when two different external components are electrically connected, the wires can pass through the wiring channels 411 of the first rotary shaft set 2 and the wiring channel 411 of the second rotary shaft set 3 successively.

In the present embodiment, the rotary shaft further includes a mounting box 5, a mounting base 1 is fixed in the mounting box 5, and one end of the rotary shaft 41 extends into the mounting box 5 and is rotatably connected to the mounting base 1.

In the present embodiment, the number of the second rotary shaft sets 3 is two or more, and the other ends of the wiring channels 411 of the two or more second rotary shaft sets 3 all correspond to the other ends of the wiring channels 411 of the first rotary shaft set 2. The arrangement in which the number of the second rotary shaft set 3 is two or more makes it possible to make the connection between the rotary shaft and the external component more stable. Specifically, the rotary shaft may be connected to two or more external components by two or more second rotary shaft sets 3, respectively, or may be connected to one external component by two or more second rotary shaft sets 3 at the same time.

In the present embodiment, the mounting base 1 includes a first mounting member 14 having two ends bent at a right angle to form a second mounting member 15, the rotary shaft 41 of the first rotary shaft set 2 has one end rotatably connected to the first mounting member 14, and the rotary shafts 41 of the two second rotary shaft sets 3 respectively have one end rotatably connected to the second mounting members 15 at two ends of the first mounting member 14.

In the present embodiment, the mounting base 1 is provided with a rotation hole 11 through which one end of the rotary shaft 41 passes to be rotatably connected with the mounting base 1. Specifically, the first mounting member 14 and the second mounting members 15 at two ends thereof are each provided with a rotation hole 11.

In the present embodiment, the rotary shaft unit 4 further includes a damping sheet 42 for controlling the rotational damping between the mounting base 1 and the rotary shaft 41, where the damping sheet 42 is sleeved over the rotary shaft 41, and the damping sheet 42 abuts against the mounting base 1. When the rotary shaft 41 rotates, the damping sheet 42 is synchronously driven to rotate, and the abutment between the damping sheet 42 and the mounting base 1 damps the rotation process to some extent.

In the present embodiment, the damping sheet 42 is sleeved at one end of the rotary shaft 41, and first flat positions 413 for limiting the rotation of the damping sheet 42 are provided at one end of the rotary shaft 41.

In the present embodiment, the first flat positions 413 are provided on two opposite sides of one end of the rotary shaft 41.

In the present embodiment, the rotary shaft unit 4 further includes a spring set 43 and a pressing ring 44, where the spring set 43 is sleeved at one end of the rotary shaft 41, and one end of the spring set 43 abuts against the damping sheet 42; the pressing ring 44 is movably sleeved at one end of the rotary shaft 41 via a thread, and the pressing ring 44 abuts against the other end of the spring set 43. The rotational damping during rotation of the rotary shaft 41 can be adjusted by rotating the pressing ring 44 to compress the spring set 43, thereby controlling the abutment force of the spring set 43 against the damping sheet 42.

In the present embodiment, the spring set 43 includes a plurality of disc-shaped spring pieces 431.

In the present embodiment, a positioning protrusion 421 is provided on one side of the damping sheet 42, and a positioning groove 12 corresponding to the positioning protrusion 421 is provided on the mounting base 1. When the damping sheet 42 is rotated with respect to the mounting base 1, a positioning effect is provided by the cooperation of the positioning protrusion 421 and the positioning groove 12. Specifically, the number of the positioning grooves 12 may be a plurality.

In the present embodiment, first inclined faces 4211 are provided on two sides of the positioning protrusion 421, second inclined faces 121 are provided on two sides of the positioning groove 12, and the first inclined faces 4211 on two sides of the positioning protrusion 421 respectively correspond to the second inclined faces 121 on two sides of the positioning groove 12. The first inclined faces 4211 and the second inclined faces 121 are engaged so that the positioning protrusion 421 can be more smoothly disengaged from the positioning groove 12.

In the present embodiment, a limiting portion 451 for limiting the rotational angle of the rotary shaft 41 is provided at the other end of the rotary shaft 41, and the mounting base 1 is provided with a limiting protrusion 13 corresponding to the limiting portion 451.

In the present embodiment, a limiting ring 45 is sleeved at the other end of the rotary shaft 41, and the limiting portion 451 is provided on the limiting ring 45.

In the present embodiment, a second flat position 414 for restricting the rotation of the limiting ring 45 is provided at the other end of the rotary shaft 41.

In the present embodiment, the second flat positions 414 are provided on two opposite sides of the other end of the rotary shaft 41.

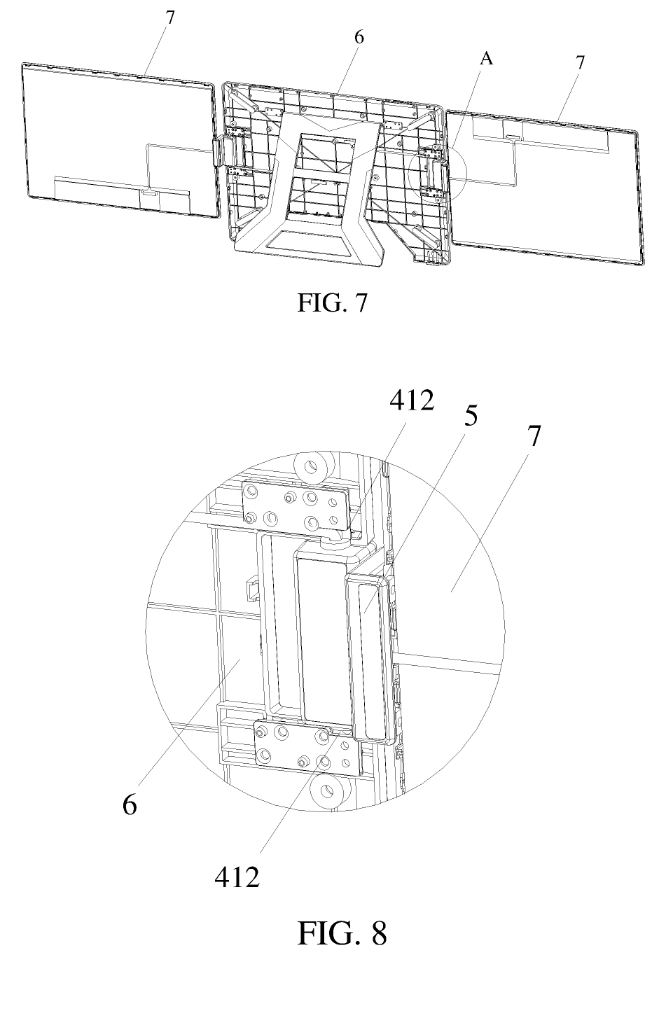

With reference to FIGS. 1-8, the present embodiment also provides a screen apparatus including a body 6, a screen 7 and a rotary shaft, where the body 6 is connected to the connection ends 412 of two second rotary shaft sets 3, the screen 7 is connected to a mounting base 1, and the body 6 passes through a wiring channel 411 of the second rotary shaft set 3 and a wiring channel 411 of the first rotary shaft set 2 successively so as to be electrically connected to the screen 7. Based on the arrangement of the rotary shaft, the body 6 and the screen 7 not only have the function of adjustment of rotation at multiple angles; at the same time, the connection mode between the body 6 and the screen 7 is a hidden connection mode through the wiring channel 411 of the second rotary shaft set 3 and the wiring channel 411 of the first rotary shaft set 2, and this connection mode is not only more stable and reliable, but also can effectively avoid potential safety hazards. Specifically, the mounting base 1 of the rotary shaft is fixed to the screen 7 by means of a mounting box 5 on the outer side thereof.

In the present embodiment, the screen 7 and the rotary shaft are both two or more, the body 6 is connected to the connection ends 412 of the two or more rotary shafts, the two or more screens 7 are connected to the mounting bases of the two or more rotary shafts, respectively, and the body 6 is electrically connected to the two or more screens 7 through the two or more rotary shafts, respectively. Specifically, the screen 7 and the rotary shaft are both two, where the two rotary shafts are respectively located at the left and right sides of the body 6, and the two screens 7 are respectively connected to the mounting bases of the rotary shafts at the left and right sides of the body 6.

The above is merely a preferred embodiment of the present invention and is not intended to limit the scope of the present invention. Any modifications, equivalent replacements, or improvements made within the spirit and principles of the present invention shall be included within the protection scope of the present invention.

1. A rotary shaft rotatable at multiple angles, comprising a mounting base, a first rotary shaft set for performing a first angle rotation on the mounting base, and a second rotary shaft set for performing a second angle rotation on the mounting base, wherein the first rotary shaft set and the second rotary shaft set respectively comprise a rotary shaft unit; and
the rotary shaft unit comprises a rotary shaft having one end rotatably connected to the mounting base and the other end provided with a connection end connected to an external component, a wiring channel extending through two ends thereof is provided in the rotary shaft, and has one end correspond to the connection end and the other end correspond to the other end of the wiring channel of the second rotary shaft set.

2. The rotary shaft rotatable at multiple angles according to claim 1, wherein the number of the second rotary shaft sets is two or more, and the other ends of the wiring channels of the two or more second rotary shaft sets correspond to the other ends of the wiring channels of the first rotary shaft set.

3. The rotary shaft rotatable at multiple angles according to claim 1, wherein the mounting base comprises a first mounting member having one end bent to form a second mounting member, the rotary shaft of the first rotary shaft set has one end rotatably connected to the first mounting member, and the rotary shaft of the second rotary shaft set has one end rotatably connected to the second mounting member.

4. The rotary shaft rotatable at multiple angles according to claim 1, wherein the rotary shaft unit further comprises a damping sheet for controlling rotational damping between the mounting base and the rotary shaft, the damping sheet is sleeved over the rotary shaft, and the damping sheet abuts against the mounting base; and
the damping sheet is sleeved at one end of the rotary shaft, and first flat positions for limiting the rotation of the damping sheet are provided at one end of the rotary shaft.

5. The rotary shaft rotatable at multiple angles according to claim 4, wherein the rotary shaft unit further comprises a spring set and a pressing ring, the spring set is sleeved at one end of the rotary shaft, and one end of the spring set abuts against the damping sheet; the pressing ring is movably sleeved at one end of the rotary shaft via a thread, and the pressing ring abuts against the other end of the spring set; and
the spring set comprises a plurality of disc-shaped spring pieces.

6. The rotary shaft rotatable at multiple angles according to claim 4, wherein a positioning protrusion is provided on one side of the damping sheet, and a positioning groove corresponding to the positioning protrusion is provided on the mounting base; and
first inclined faces are provided on two sides of the positioning protrusion, second inclined faces are provided on two sides of the positioning groove, and the first inclined faces on two sides of the positioning protrusion respectively correspond to the second inclined faces on the two sides of the positioning groove.

7. The rotary shaft rotatable at multiple angles according to claim 1, wherein a limiting portion for limiting the rotation angle of the rotary shaft is provided at the other end of the rotary shaft, and the mounting base is provided with a limiting protrusion corresponding to the limiting portion.

8. The rotary shaft rotatable at multiple angles according to claim 7, wherein a limiting ring is sleeved at the other end of the rotary shaft, and the limiting portion is provided on the limiting ring; and
the other end of the rotary shaft is provided with a second flat position for limiting rotation of the limiting ring.

9. A screen apparatus, comprising a body, a screen, and the rotary shaft according to claim 1, wherein the body is connected to the connection end, the screen is connected to the mounting base, and the body passes through the wiring channel of the second rotary shaft set and the wiring channel of the first rotary shaft set to be electrically connected to the screen.

10. The screen apparatus according to claim 9, wherein the screen and the rotary shaft are both two or more in number, the body is connected to the connection ends of the two or more rotary shafts, the two or more screens are connected to the mounting bases of the two or more rotary shafts, respectively, and the body is electrically connected to the two or more screens through the two or more rotary shafts, respectively.
